(19) United States
(12) Patent Application Publication
(10) Pub. No.: US 2010/0011882 A1
(43) Pub. Date: Jan. 21, 2010

(54) METHOD FOR OPERATING A VIBRATORY MEASURING INSTRUMENT, AND CORRESPONDING INSTRUMENT

(75) Inventors: Joerg Gebhardt, Mainz (DE); Frank Kassubek, Rheinfelden (DE); Lothar Deppe, Goettingen (DE); Steffen Keller, Konstanz (DE); Rene Friedrichs, Rosdorf (DE)

Correspondence Address: DARBY & DARBY P.C., P.O. BOX 770, Church Street Station, New York, NY, 10008-0770, US

(73) Assignee: ABB Patent GmbH, Ladenburg (DE)

(21) Appl. No.: 12/520,692

(22) PCT Filed: Dec. 20, 2007
(86) PCT No.: PCT/EP07/11237

§ 371 Date: Jun. 22, 2009

(30) Foreign Application Priority Data
Dec. 21, 2006 (DE) 10 2006 060 595.0
Dec. 19, 2007 (DE) 10 2007 061 690.4

(51) Int. Cl. G01F 1/84

(52) U.S. Cl. 73/861.357

(57) ABSTRACT

A method for operation of a vibratory measurement instrument comprises flowing a fluid through at least one measurement tube; causing the measuring tube to oscillate mechanically using an oscillation production unit; detecting an oscillation behavior of the tube using at least one oscillation sensor; determining at least one of a mass flow, a viscosity, and a density in a narrowband frequency range based on the oscillation behavior; evaluating at least one of the mass flow, the viscosity, and the density using signal processing of an electronics unit; and evaluating the oscillation behavior at least at times in a broadband frequency range using the electronics unit.

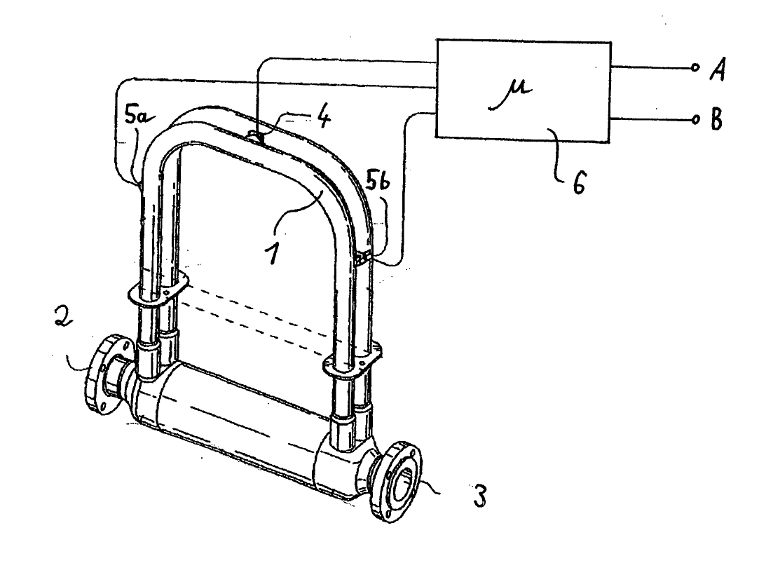

This is a U.S. National Phase Application under 35 U.S.C. § 171 of PCT/EP2007/011237, filed on Dec. 20, 2007, which claims priority to German Application No. DE 10 2006 060 595.0, filed Dec. 21, 2006 and DE 10 2007 061 690.4, filed on Dec. 19, 2007. The International Application was published in German on Jul. 3, 2008 as WO 2008/077574 under PCT article 21 (2).

The present invention relates to a method for operation of an instrument of the vibration type, in which a fluid medium can flow through at least one measurement tube, which can be caused to oscillate mechanically via an oscillation production unit, with the oscillation behavior, which varies as a function of the flow and/or the viscosity and/or the density of the fluid medium, being detected by at least one oscillation sensor in order to determine the mass flow and/or the viscosity and/or the density in a narrowband frequency range, and then being evaluated by signal processing by means of an electronics unit.

Furthermore, the invention also comprises an instrument of the vibration type itself, which can be operated using a method such as this.

### BACKGROUND

The instruments of the vibration type of interest here are also referred to as Coriolis flowmeters and are used for mechanical-flow measurement in fluid masses, and are used in installations in which the precision of the mass flow is relevant, for example in refineries, foodstuffs businesses, chemical production installations etc. The fluid media which are measured using instruments of this generic type may be of different types. The field of use extends from high-viscosity and even pasty substances such as yogurt to lightweight and low-viscosity substances, such as gasoline.

Flowmeters of this type can be distinguished on the basis of the design of the measurement tubes. For example, Coriolis flowmeters exist having one or more straight measurement tubes which are arranged parallel to one another. On the other hand, Coriolis flowmeters are in normal use which have one or more OMEGA-shaped measurement tubes arranged alongside one another. In the case of embodiments having preferably two measurement tubes, these can be connected in series or in parallel with one another for flow purposes. Recently, Coriolis flowmeters with only one straight measurement tube have been increasingly used. These flowmeters are distinguished by a simple mechanical design, which requires relatively little manufacturing effort. On the other hand, Coriolis flowmeters with only one straight measurement tube place relatively stringent requirements on good environmental conditions and manufacturing precision in order that accurate measured values can be achieved. The present invention can be applied to all known measurement tube arrangements.

In principle, a Coriolis flowmeter represents a mechanical oscillating system which is excited to oscillate at one of its natural frequencies, in order to obtain information relating to the mass flow and/or the density and/or the viscosity of the measurement media from the oscillation behavior of the measurement tube, which is influenced by Coriolis forces and is preferably detected by means of inductive sensors. Many physical parameters which are dependent on the natural frequency can in this case be determined by signal processing.

WO 01/75339 A2 discloses a method of this generic type for operation of a Coriolis flowmeter. In this case, the measurement tube is excited in a first oscillation form and in a second oscillation form, which is independent of the first oscillation form. The electronics unit which evaluates the oscillation behavior of the measurement tube uses models as the basis to determine characteristic physical operating parameters during operation.

The various oscillation forms may preferably be formed phase-shifted through 90° in the same oscillation mode. This method makes it possible to determine a multiplicity of characteristic physical operating parameters. This particularly preferably allows the zero point and the sensitivity of the flowmeter to be determined. These characteristic physical operating parameters have a major influence on the accuracy of the determination of the mass flow.

However, the method described above has the disadvantage that different oscillation modes need to be implemented in order to obtain the desired characteristic physical operating parameters. The signal evaluation is carried out matched to the frequency spectrum of the chosen oscillation mode.

### SUMMARY OF THE INVENTION

An aspect of the present invention is to provide a method for operation of an instrument of the vibration type, by means of which the oscillation excitation of characteristic physical operating parameters is simplified, and the signal evaluation is made more precise.

The invention includes the method teaching that the oscillation behavior of the measurement tube is additionally evaluated by the electronics unit in a broadband frequency range, for example, in order to determine supplementary physical operating parameters, in order to increase the measurement accuracy and/or in order to correct cross-sensitivities, and/or in order to obtain supplementary information relating to the state of the instrument.

The broadband frequency evaluation may comprise known methods such as spectrum analysis, in particular Fast Fourier Transformation, FFT or DFT, furthermore single-channel and two-channel measurement methods, in order to determine the power spectral density and the autocorrelation function or cross-correlation function, or else methods such as averaging and step-function response analysis.

The zero-point phase shift and the flow sensitivity are among the supplementary physical operating parameters which can be obtained by the broadband frequency evaluation.

Furthermore, parameters obtained from the broadband frequency evaluation can be used to correct for cross-sensitivities, for example relating to the temperature, the pressure, external mechanical loads or mechanical influences on the instrument, and parasitic vibrations in the pipeline system in which the instrument has been installed.

Furthermore, diagnosis information relating to the state of the instrument or the process environment can be obtained from the broadband frequency evaluation, for example relating to the creation and/or propagation of cracks, the presence of parts that have become loose or loose parts, or the creation of deposits in the interior of the measurement tube wall.

According to one advantageous embodiment of the invention, the measurement tube is operated in a narrowband form, at one of the possible natural frequencies, in the form of single-mode excitation, by the oscillation production unit.

According to a further advantageous embodiment, the measurement tube is operated in a broadband manner, at a number of natural frequencies, by the oscillation production unit.

According to a further advantageous embodiment, the measurement tube is excited by the oscillation production unit, with a broadband signal which comprises a number of natural frequencies at the same time.

According to a further advantageous embodiment, the measurement tube is excited by the oscillation production unit, such that the frequency of a narrowband excitation signal is varied in a broadband frequency range. This can be done in the form of a swept-frequency generator, or in the form of a single frequency scan.

According to a further advantageous embodiment, the measurement tube is excited by broadband mechanical disturbance oscillations from the environment of the instrument, in a broadband manner, at a number of natural frequencies. This type of excitation is also referred to as passive excitation. In this case, use is made of the fact that broadband noise, such as that which is introduced into the instrument as a result of mechanical vibration of the pipe system surrounding the instrument, excites each of the natural modes with a certain amount of energy. In particular, the external noise can be produced by pumping or cavitation noise in the flow system in which the instrument is installed.

According to a further advantageous embodiment, a broadband excitation is superimposed on a narrowband excitation of the measurement tube.

According to a further advantageous embodiment, the excitation of the measurement tube is carried out alternately in a narrowband manner and a broadband manner.

According to a further advantageous embodiment the amplitude of lower-frequency oscillations and higher-frequency oscillations adjacent to the resonant frequency, as characteristic operating parameters, is determined as an indicator of ageing processes.

According to a further advantageous embodiment, the measurement tube is excited alternately at least two different natural frequencies by the oscillation production unit.

According to a further advantageous embodiment, the stress in the measurement tube, as a characteristic operating parameter, is determined as a function of the respective resonant frequency.

According to a further advantageous embodiment, the zero-point phase difference and the flow sensitivity are determined as characteristic operating parameters.

According to a further advantageous embodiment, broadband excitation, which is likewise produced by the oscillation production unit, is superimposed on the narrowband excitation of the measurement tube.

With regard to an instrument of the vibration tab, the invention includes the technical teaching that the electronics unit additionally evaluates the oscillation behavior of the measurement tube in a broadband frequency range, in order to determine supplementary physical operating parameters, in order to increase the measurement accuracy and/or in order to correct cross-sensitivities, and/or in order to obtain supplementary information relating to the state of the instrument.

According to a further advantageous embodiment, the oscillation production unit operates the measurement tube in a narrowband manner at one of the possible natural frequencies, in the form of single-mode excitation.

According to a further advantageous embodiment, the oscillation production unit operates the measurement tube in a broadband manner at a number of natural frequencies.

According to a further advantageous embodiment, the oscillation production unit excites the measurement tube with a broadband signal which comprises a number of natural frequencies at the same time.

According to a further advantageous embodiment, the oscillation production unit excites the measurement tube such that the frequency of a narrowband excitation signal is varied in a broadband frequency range.

According to a further advantageous embodiment, the broadband mechanical disturbance oscillations from the environment of the instrument excite the measurement tube in a broadband manner at a number of natural frequencies.

According to a further advantageous embodiment, the measurement tube is excited by a narrowband excitation on which a broadband excitation is superimposed.

According to a further advantageous embodiment, the measurement tube is excited alternately in a narrowband manner and a broadband manner.

According to a further advantageous embodiment, the broadband frequency range to be evaluated by the electronics unit covers a plurality of kilohertz.

According to a further advantageous embodiment, the measurement tube, which can oscillate, is designed to be straight or curved, such that a plurality of natural frequencies which are effective for measurement occur.

According to a further advantageous embodiment, the electronics unit provides not only information A which represents the flow value of the measurement medium but also diagnosis information B relating to the state of the flowmeter.

The advantage of the solution according to the invention is, in particular, that the complete spectrum of the oscillation behavior of the measurement tube can be used to obtain reliable information about characteristic physical operating parameters, even though the oscillation excitation of the measurement tube may also be only over a narrow bandwidth. This makes it possible to compensate for different cross-sensitivities and to diagnose the instrument integrity. This is because higher-frequency oscillations and lower-frequency oscillations occur in addition to the resonant frequency in the broadband frequency range of the oscillation behavior of the measurement tube, and have harmonic or sub-harmonic features which are also indirectly suitable as an indicator of ageing processes and the like.

Within the scope of the present invention, it is also feasible for the measurement tube to be excited at least two different natural frequencies by the oscillation production unit. This allows the mechanical stress in the measurement tube, as a characteristic operating parameter, to be determined as a function of the respective correspondingly changing resonant frequency.

Furthermore, it is possible to superimpose a broadband excitation, which is likewise produced by the oscillation production unit, on the narrowband excitation according to the invention of the measurement tube. As an alternative to this, it is also possible to change between the oscillation modes. Implementation of a sequence such as this of different excitation modes makes it possible to evaluate non-linearities in the measurement system which can be used, in particular, as an indicator of ageing processes. This and other diagnosis information about the state of the flowmeter can be provided on the output side of the electronics unit for further processing, in addition to information which represents the flow volume of the measurement medium.

### BRIEF DESCRIPTION OF THE DRAWINGS

Further measures which improve the invention will be described in more detail in the following text together with the description of one preferred exemplary embodiment of the invention, with reference to the single FIGURE.

The only FIGURE shows a schematic illustration of a Coriolis flowmeter.

### DETAILED DESCRIPTION

As can be seen from the FIGURE, the Coriolis flowmeter comprises a curved measurement tube 1 which is arranged in a duplicated form and is arranged between an inlet-flow flange 2 and an outlet-flow flange 3. The measurement medium, which flows between the inlet-flow flange 2 and the outlet-flow flange 3, including the measurement tube 1, is caused to oscillate mechanically, together with the measurement tube 1, by an oscillation production unit 4. A split sensor unit 5a, 5b, which is fitted to the measurement tube 1 on both sides of the oscillation production unit 4 in the indicated example, detects the oscillation behavior of the measurement tube 1 as a response to the oscillation excitation. The measurement signal from the sensor unit 5a, 5b is supplied to the input side of an electronics unit 6, for signal processing.

While the oscillation production unit 4 excites the measurement tube 1 only in a narrowband manner at one of the possible frequencies, the electronics unit 6 evaluates the oscillation behavior of the measurement tube 1 in a frequency range which has a broad bandwidth in comparison to this. This is based on the assumption that the sensor unit 5a and 5b is tuned to detect a broad frequency spectrum of a plurality of kilohertz.

In addition the first information A which represents the flow value of the measurement medium, the electronics unit 6 also provides diagnosis information B about the physical state of the flowmeter, in particular with regard to the ageing process, which diagnosis information B can either be displayed directly or can be passed to a superordinate control unit for further signal processing.

In the course of the evaluation of characteristic operating parameters, the electronics unit 6 evaluates in particular the amplitude of lower-frequency and higher-frequency oscillations which occur in addition to the resonant frequency of the narrowband oscillation excitation, and are suitable as an indicator of ageing processes. Disturbances resulting from temperature fluctuations and the like can be found by means of further characteristic operating parameters, such as the zero point, phase difference and/or flow sensitivity of the instrument, in order to obtain the measurement accuracy by appropriate signal-processing compensation measures.

The electronics unit 6 is a microprocessor with high computation power, in order that it can carry out the extensive signal analysis functions.

One particular advantage of the invention is that, in general, no additional sensor hardware is required in order to obtain a range of additional information from the measurement signals from the sensors 5a, 5b. This is a software-based solution which can be implemented in available, high-performance signal processors.

The invention is not restricted to the exemplary embodiment described above. In fact, modifications thereof are also feasible, which are covered by the scope of protection of the following claims. For example, the solution according to the invention can be used other than in conjunction with a curved measurement tube. In particular, Coriolis flowmeters with single or double versions of a straight measurement tube can be operated using the method according to the invention.

### LIST OF REFERENCE SYMBOLS

1 Measurement tube
2 Inlet-flow flange
3 Outlet-flow flange
4 Oscillation production unit
5 Sensor unit
6 Electronics unit
A Flow value/information
B Diagnosis information

1-24. (canceled)

25. A method for operation of a vibratory measurement instrument comprising:
flowing a fluid through at least one measurement tube;
causing the measuring tube to oscillate mechanically using an oscillation production unit;
detecting an oscillation behavior of the tube using at least one oscillation sensor;
determining at least one of a mass flow, a viscosity, and a density in a narrowband frequency range based on the oscillation behavior;
evaluating at least one of the mass flow, the viscosity, and the density using signal processing of an electronics unit; and
evaluating the oscillation behavior at least at times in a broadband frequency range using the electronics unit.

26. The method as recited in claim 25 wherein the evaluating of the oscillation behavior in a broadband frequency range is performed so as to at least one of determine supplementary physical operating parameters, increase measurement accuracy, correct cross-sensitivities, and obtain supplementary information relating to at least one of a state of the instrument and a process environment.

27. The method as recited in claim 25, further comprising operating the measurement tube using the oscillation production unit in a narrowband form at a natural frequency in a single-mode excitation form.

28. The method as recited in claim 25, wherein a broadband frequency range evaluated by the electronics unit includes a plurality of kilohertz.

29. The method as recited in claim 25, further comprising operating the measurement tube using the oscillation production unit in a broadband form at least one natural frequency.

30. The method as recited in claim 29, further comprising exciting the measurement tube using the oscillation production unit using a broadband signal that includes a plurality of natural frequencies simultaneously.

31. The method as recited in claim 29, further comprising exciting the measurement tube using the oscillation production unit so as to vary a frequency of a narrowband excitation signal in a broadband frequency range.

32. The method as recited in claim 25, further comprising exciting the measurement tube using broadband mechanical disturbance oscillations from an environment of the instrument in a broadband manner at a plurality of natural frequencies.

33. The method as recited in claim 27, further comprising superimposing a broadband excitation on a narrowband excitation.

34. The method as recited in claim 27, further comprising alternating an excitation of the measurement tube in the narrowband form and in a broadband form.

35. The method as recited in claim 25, further comprising determining an amplitude of lower-frequency oscillations and higher-frequency oscillations adjacent to a resonant frequency as an indicator of aging processes.

36. The method as recited in claim 25, further comprising exciting the measurement tube using the oscillation production unit alternately at least two different natural frequencies.

37. The method as recited in claim 25, further comprising determining a stress in the measurement tube as a function of a respective resonant frequency.

38. The method as recited in claim 25, further comprising determining a zero-point phase difference and a flow sensitivity as characteristic operating parameters.

39. The method as recited in claim 25, further comprising producing broadband excitation using the oscillation production unit and superimposing the broadband excitation on a narrowband excitation of the measurement tube.

40. An instrument of a vibration type, comprising:
a measurement tube configured to receive a fluid therethrough;
an oscillation production unit configured to mechanically oscillate the measurement tube;
a sensor unit configured to detect an influence of an oscillation behavior of the measurement tube, the influence varying as a function of at least one of a mass flow, a viscosity, and a density of the fluid; and
an electronics unit configured to evaluate the influence using signal processing, wherein the electronics unit is additionally configured to evaluate the oscillation behavior of the measurement tube at least at times in a broadband frequency range so as to at least one of determine supplementary physical operating parameters, increase measurement accuracy, correct cross-sensitivities and obtain supplementary information relating to at least one of a state of the instrument and a process environment.

41. The instrument as recited in claim 40, wherein the oscillation production unit is configured to operate the measurement tube in a narrowband manner at a natural frequency in a single-mode excitation form.

42. The instrument as recited in claim 40, wherein the oscillation production unit is configured to operate the measurement tube in a broadband manner at a plurality of natural frequencies.

43. The instrument as recited in claim 42, wherein the oscillation production unit is configured to excite the measurement tube using a broadband signal comprising a plurality of natural frequencies simultaneously.

44. The instrument as recited in claim 42, wherein the oscillation production unit is configured to excite the measurement tube so as to vary a frequency of a narrowband excitation signal in a broadband frequency range.

45. The instrument as recited in claim 40, wherein broadband mechanical disturbance oscillations from the environment of the instrument excite the measurement tube in a broadband form at a plurality of natural frequencies.

46. The instrument as recited in claim 40, wherein the measurement tube is excited by a narrowband excitation, wherein a broadband excitation is superimposed over the narrowband excitation.

47. The instrument as recited in claim 41, wherein the measurement tube is alternately excited in the narrowband manner and in a broadband manner.

48. The instrument as recited in claim 40, wherein a broadband frequency range evaluated by the electronics unit includes a plurality of kilohertz.

49. The instrument as recited in claim 40, wherein the measurement tube is configured to oscillate and is one of straight and curved so as to enable a plurality of natural frequencies effective for measurement to occur.

50. The instrument as recited in claim 40, wherein the electronics unit provides a first information representing a flow value of the fluid and a second information, the second information including diagnostic information relating to one of the state of the flowmeter and the process environment.
